(19) United States
(12) Patent Application Publication
(10) Pub. No.: US 2003/0233366 A1
(43) Pub. Date: Dec. 18, 2003

(54) Database monitoring system with formatted report information delivery

(75) Inventors: Brian J. Kesselman, Norwalk, CT (US); Michael Gabriele, Norwalk, CT (US)

Correspondence Address: Donald J. MacDonald, McCormick, Paulding & Huber LLP, CityPlace II, 185 Asylum Street, Hartford, CT, 06103, US

(73) Assignee: Aspetuck Systems Inc., Norwalk, CT

(21) Appl. No.: 10/462,157

(22) Filed: Jun. 16, 2003

Related U.S. Application Data
(60) Provisional application No. 60/389,408, filed on Jun. 17, 2002.

(51) Int. Cl. G06F 7/00

(52) U.S. Cl. 707/100

(57) ABSTRACT

A database monitoring system that resides external to the data to be monitored. The system uses metadata to describe specific information contained in the data, or in a related external system. The system monitors for the occurrence of predetermined conditions or events on a scheduled basis. Upon occurrence of the event, the system takes specific action which can include the creation of a formatted report, containing extracts from the database, which can be sent to a one or more destinations including via email to recipients determined based on data included on the report or recipients with a pre-defined relationship to the data included on the report.

Cross REFERENCE TO RELATED APPLICATION

This application is related to pending U.S. Provisional Patent Application No. 60/389,408 filed Jun. 17,2002 entitled “DATABASE MONITORING SYSTEM WITH FORMATTED REPORT INFORMATION DELIVERY”. Applicants claim priority of the above-identified application which is incorporated herein by reference.

### FIELD OF THE INVENTION

The present invention relates to the monitoring of a database from an external system for existence of a predetermined condition, and distribution of formatted report information to one or destinations, including destinations based on the content of the report, according to a procedure which may be defined using metadata.

### BACKGROUND OF THE INVENTION

Traditionally, information such as people centric information is stored in a relational database or data set to allow quick maintenance, retrieval and reporting. Some examples of this type of data are sales contact management databases, payroll databases and human resource information systems. The data in these data sets lends itself to the occurrence of certain predetermined conditions known as events, which can be monitored. An example would include “Were there any new hires this week?” in a Human Resource Information System (HRIS). Traditionally, event monitoring has been done at the database level using triggers as in SQL Server or other auditing mechanisms, and generation of formatted reports has been done on a request basis from an application or website, or pre-built on a regular basis (scheduled) and deposited to a specific data repository (file folder, email recipient list or website). Alternatively, some programs have used snapshots of the data in full or compressed formats, and compared them to identify changes. The results of the comparison have triggered events that can deliver the data to specified locations. Other systems that are designed for workflow have been able to disseminate information to groups of recipients. Traditionally these have been custom built solutions that include both the data to be disseminated and the formatting tools to do the distribution. An example of this would be IBM's Lotus Notes® which can be used to create a people centric database and deliver information to the recipients based on specific events.

The problem exists that many monitoring systems have been built into the database and therefore are exclusively used for the database structure to which they are attached. An additional problem has been that the occurrence of a predetermined condition (event) has been able to trigger some action, including email notifications, but has not been able to send formatted reports to destinations that may be determined based on the data on the report such as to people listed on a report, and/or people with a pre-determined relationship to the data on the formatted presentation report. Additionally, many monitoring systems require the end user to have specific knowledge of the database structure in order to create and maintain the monitoring of the events.

The need exists to use an external system to monitor multiple databases such as people centric databases, for the occurrence of specific predetermined conditions. This system should be able to be configured to work with multiple different databases with unique structures and define those databases to enable simplified creation and maintenance of the event procedure definitions. The system needs to be able to create the formatted presentation reports. The system needs to be able to define and store event procedures to be monitored, and respond to the occurrence based on the event procedure definition such as with the creation and distribution of formatted presentation reports to recipients and destinations which may include a list of people or destinations with a specific relation to the data on the report individually or in aggregate, as well as related lists. These reports need to be distributed in multiple formats to allow the recipient person or system to read the results.

### SUMMARY OF THE INVENTION

The present invention provides a method and apparatus for monitoring an external database. The apparatus includes a server having a system database and a user interface coupled thereto. The server is connectable with one or more external databases that contain stored data to be monitored. The system database has metadata stored therein related to the external database and the monitoring thereof. The server includes an executable program for evaluating the data stored in the external database based on information derived from the metadata. The server can be coupled to the external database through a network.

The present invention has further capability to execute processes as a result of the evaluations and/or create, format and distribute reports based on the metadata and the evaluations to email, file and/or printer recipients. The destinations for the reports can be predefined or determined based on the results of the evaluations and the content of the reports. Additionally the evaluations and processes can be grouped together and delivered in aggregate to like destinations.

The apparatus can process the evaluations and generate responses including reports based on a specified frequency using a timer or other means or apparatus or on demand. The function of the apparatus of the present invention can be done on one or more servers such that the apparatus is scaleable.

The present invention also provides a method for monitoring one or more external databases using a server having access to a system database wherein the system database includes metadata related to each of the external databases to be monitored. The method includes accessing at least a portion of the stored data and evaluating it based on the metadata. The present invention includes the method for combining these evaluation functions and related processing into an event procedure object.

Additionally, the method can include a method for generating reports based on the external data, the evaluations or the metadata. It includes a method for forwarding the reports to one or more destinations. The destinations may be determined based on the content of the report, the metadata and/or the evaluations. The reports can be formatted based on information in the metadata or the destination thereof.

The method also provides for a user to create, modify and remove the metadata as needed.

Additionally provided is a method for grouping the events procedure objects for ordering or optimizing the processing thereof, including a capability to deliver reports to like destinations in aggregate, and to set the frequency of the processing of event procedure objects separately or in aggregate.

### BRIEF DESCRIPTION OF THE DRAWINGS

FIG. 1 is a diagram showing an overview of the apparatus within its place in the environment of the present invention.

FIG. 2 is a diagram showing the basic functionality of the environment according to the present invention and example relationships of the data and processing objects within the environment of the present invention.

FIG. 3 is a diagram showing an example of the process used to change from “service mode” to “maintenance mode” and the functionality of the Event Procedure Catalog Queue Manager object.

FIG. 4 is a diagram showing an example of the process of executing a Event Procedure Catalog object.

FIG. 5 is a diagram showing an example of the process of executing a Event object.

FIG. 6 is a diagram showing an example of the Run Report sub-process.

FIG. 7 is a diagram showing an example of executing a Script object.

FIG. 8 is a diagram showing an example of the sub-process of outputting a Report object.

FIGS. 9 and 10 are sample of screens from the user interface of this detailed implementation of the invention.

### DETAILED DESCRIPTION OF THE INVENTION

System Overview

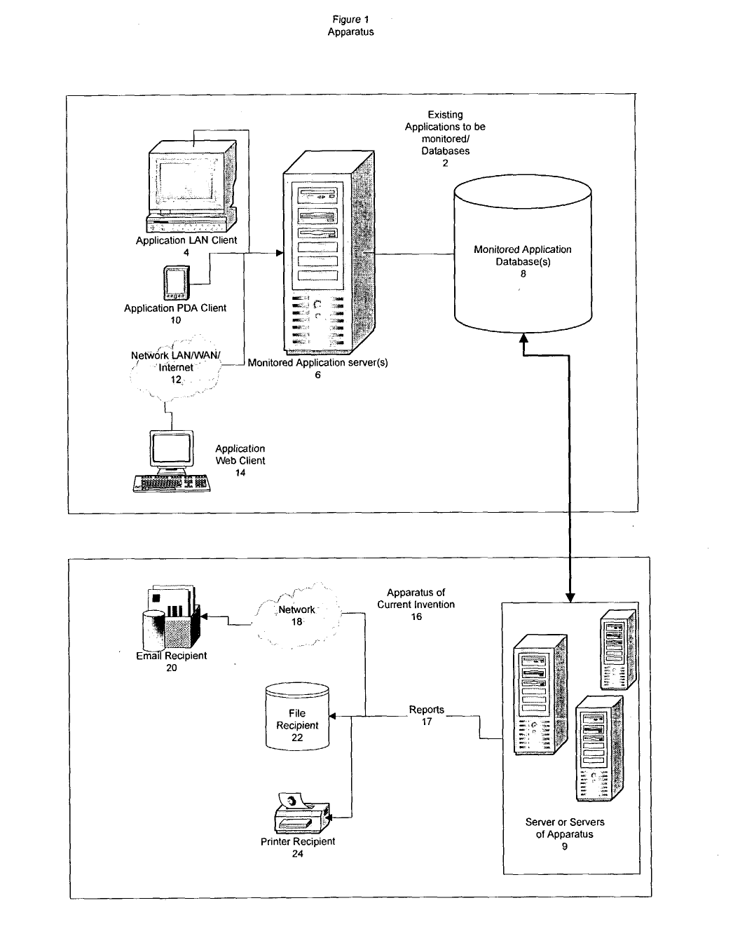

Referring to FIG. 1, applications 2 exist which store data that is created, modified and deleted from one or more databases 8. The creation, modification and deletion may happen according to the procedures and rules set in the logic of the application 6 and the input received from one or more sources such as an application client 4, PDA client 10, or web client 14. Other possible sources may include other applications, human interface devices, processes designed within the application's logic or other data sources.

According to the present invention, there is provided a method and apparatus for monitoring the database 8 or databases that applications 2 use for data storage and retrieval. These databases are external to the apparatus of the present invention and may be connectable through a network. The monitoring of said databases can be done by an apparatus of the present invention 9 according to predefined procedures, and actions can be taken in response to the occurrence or existence of predefined conditions. These actions can include the creation and distribution of documents including formatted reports 17 to one or more destinations including email recipients 20, file recipients 22 and printer recipients 24 any or all of which might be directly wired or might reside remotely across a network or the internet 18. The definitions of the procedures to monitor and respond as outlined are stored and maintained using metadata which describes technical aspects of the monitored database and the distribution methods and destinations. This metadata can facilitate the changing of the monitoring procedure definitions and distribution definitions, as well as the configuration of said monitoring procedure definitions and distribution definitions by the developers, implementors, administrators and/or users of the present invention. Further provided is a method to group the distributed results based on destination.

Another aspect of the invention is to provide a means for optimization of the processing by separating the system into two or more segments or servers shown in figure one as item 9 which work in concert to provide the same functionality as a singular system with distributed effort, and further optimizing that distributed effort by use of mathematical formulae to determine the best scenario for execution of individual tasks by a segment of the apparatus.

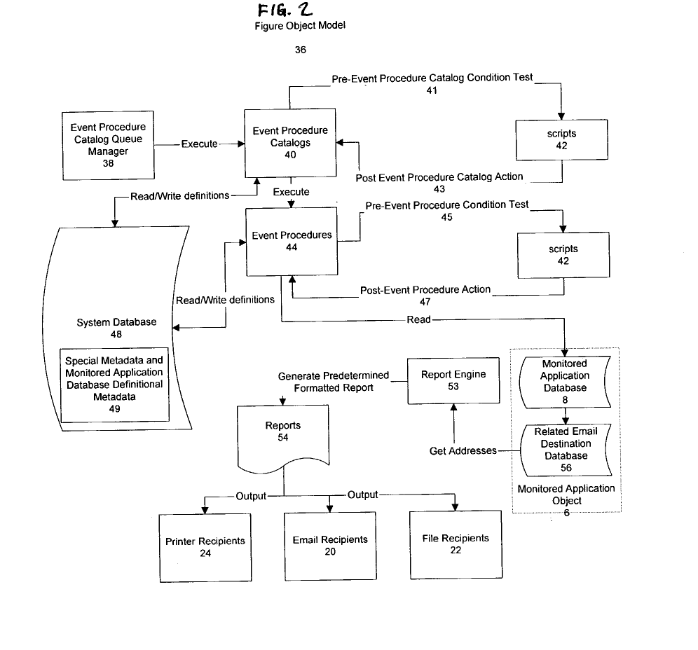

This invention includes apparatus and method for the monitoring of an application's 6 database 8 which is a database external to the apparatus and data of the present invention, such as Human Resource Information Systems (HRIS), payroll systems, time keeping systems, benefit enrollment systems, sales contact management system, financial applications or other systems,. These applications 6 may be server based, or client based and may derive their data input from external sources such as LAN clients, personal digital assistant or handheld clients, web-based clients utilizing a browser or other means of communication (remotely through the internet or other communication path), or other sources of data including the logic of the application. The input mechanism for the data is not material to the invention as the invention is concerned with the data after creation, modification or deletion and not inherently concerned with the source of the data. According to the present invention, there is provided a method of defining a data structure for a Monitored Application Database 8 using identifiers which are known as metadata (referring to FIG. 2) 49, which is defined within the art as definitional data that provides information about, or documentation of, other data managed within an application or environment.

A system database 48 is provided, the system database 48 including therein an object associated with each metadata 49 entry. There exist Event Procedures 44, which comprise rules which govern the monitoring for specific conditions and the responses to make when the conditions met. These Event Procedure's 44 definitions are stored in a provided database, the system database 48. The definitions include but are not limited to the creation and distribution of a formatted presentation report 54. Each Event Procedure 44 may contain references to a test or tests 41 that may be performed to indicate the existence of predetermined conditions, the appropriate tool or report engine 53 to use to create reports 54, the appropriate formatted presentation report or reports 54 to create on the occurrence of the predetermined condition(s), the destination or destinations to which the report 54 will be directed and optionally an action script 42 which is a command or set of commands to be executed 43 upon completion of the distribution of the formatted presentation report.

A formatted presentation report 54 is a formatted extract of the data which may include data from the monitored application database 8, fixed text items, calculated fields, summary items, form layout elements, and/or other graphical or textual representations to give a formatted output. Reports 54 are documents which may exist independently from the medium in which they are distributed and may be output in many different file formats including but not limited to: ASCII, Microsoft Word for Windows®, Microsoft Excel®, Adobe® PDF, printed documents, documents opened in a window on the user's system and other defined formats known now or in the future. An example of the independence from the distribution medium is that a report might be attached to an email as a file, but the report is not an integral part of the email, nor is the email required for the existence of the report. A destination is a place to which the report can be sent, including email recipients 20, folders in a file system 22, printers on a computer or network 24 and windows for display on the host systems display device.

The determination of email destinations can be made based on the content of the report. This is done by relating the content of the report to information stored in the related email destination database 56 which refers to a database that contains email addressing information for recipients, and a definable relationship to the information in the monitored application database 8. This email addressing information data may be contained within the monitored application database 8, in which case references to the related email destination database 56 could be considered as references to the email addressing information within the monitored application database 8, or the related email destination database 56 may be separate from the monitored application database 8.

Event Procedures 44 can be run based on a scheduled frequency. Event Procedure Catalogs 40 are defined below and said Event Procedure Catalogs 40 contain information defining the frequency at which each Event Procedure 44 is to be tested and executed including the starting date and time of the Event Procedure Catalog 40, and the elapsed time required between executions of the Event Procedure Catalog 40. The definitions of the Event Procedure Catalogs 40 are stored in a provided database, the system database 48 While the invention can exist if each Event Procedure 44 were run independently on its own schedule, therefore eliminating the need for separate Event Procedure Catalogs 40, added benefits can be achieved by separating the two. Each Event Procedure Catalog 40 can contain multiple Event Procedures 44. Event Procedure Catalogs 40 may also contain references to a test 45 to be performed before executing the referenced Event Procedures 44, in order to determine whether to continue with the execution of the Event Procedures 44. This test is defined by a script 42, which may return a value and/or error status upon completion. Each Event Procedure Catalog 40 is executed on a periodic or regular basis.

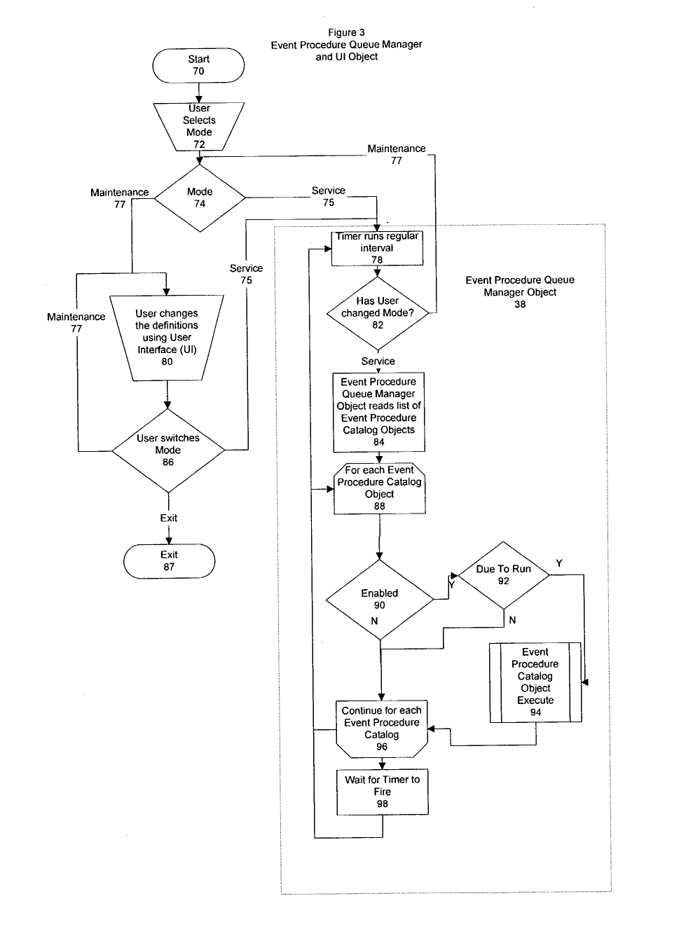

An aspect of the invention is having a method to determine when an Event Procedure 44 or group of Event Procedures in an Event Procedure Catalog 40 are due to be executed. The apparatus which performs the steps of this method is provided as the Event Procedure Catalog Queue Manager 38. The Event Procedure Catalog Queue Manager 38 evaluates the collection of Event Procedure Catalogs 40 and determines whether they are to be due to run by having passed the predefined date, time and duration referenced in the Event Procedure Catalog 40 definition. When a Event Procedure Catalog 40 is determined to be due to run by having passed the predefined date, time and duration, the Event Procedure Catalog Queue Manager 38 executes any test for a predefined condition, as defined by a script 42, referenced in the Event Procedure Catalog 40 definition. When a predefined condition test returns a positive result, or if no test is defined (resulting in a default positive), the Event Procedures 44 referenced in the Event Procedure Catalog's 40 definition are executed, each of which may: run its own test 41 for predetermined conditions, create reports 54 by invoking the report engine 53 referenced in the Event Procedure 44's definition, and execute 43 sets of commands stored in post-event action scripts 42 which can contain a set of commands for the system to execute. These commands may include taking action on the reports 54 that were created or adding, modifying or deleting data in the Monitored Application Database 8. The resultant reports can be aggregated for distribution based on the distinct list of destinations for all Event Procedures 44 within the Event Procedure Catalog's 40 definition, therefore increasing the efficiency of the distribution process. The Event Procedure Catalog 40 can then execute sets of commands stored in post-event procedure catalog action scripts 47 which can contain a set of commands for the system to execute. These commands may include taking action on the reports 54 that were created or adding, modifying or deleting data in the Monitored Application Database 8. The process of evaluating when Event Procedure Catalogs 40 are due to run and executing them, which defines Service Mode (shown on FIG. 3 as connectot 75) is repeated by the Event Procedure Catalog Queue Manager 38 for so long as the Event Procedure Catalog Queue Manager 38 is set to execute Event Procedure Catalogs.

An aspect of the present invention is creating a software mechanism for storage, retrieval and utilization of data for use in a system having at least one external Monitored Application Database 8 identified therein, wherein the Monitored Application Database 8 contains data to be tested for predetermined conditions 41 and 45 and said system calls the report engine 53 which creates presentation reports 54 formatted in a predetermined manner and distributed to one or more destinations (shown as items 20, 22, and 24 on FIG. 1), the system including a system database 48 to store the information required for the testing, creation of presentation reports 54 and distribution, a test mechanism 42 for determining the existence of predetermined conditions, a formatted presentation report generator using the report engine 53 responsive to said test mechanism which creates the presentation reports 54 based on a predefined format and customized based on information stored in the system database 48, a queue manager 38 for determining when to test for the predetermined condition(s) 41 45, and a distribution mechanism to send said formatted presentation reports 54 to selected destinations. In this detailed implementation of the invention, said software mechanisms are used to perform the maintenance of the data, which is stored in the system database 48, required for the system to function. The software mechanisms also can perform the execution of the Event Procedures 44 which comprise the definition of the predetermined condition 41 to be tested, the response to be generated and the distribution thereof.

An aspect of the present invention is having a system with said system comprises identifiers in the form of metadata 49 including; database identifiers for information relating to connection to the Monitored Application Database 8, presentation identifiers for predetermined references to specific data fields, or queries based on specific data fields, within the Monitored Application Database 8 for enabling the customization of the formatted presentation reports 54. The present invention further comprises destination identifiers for references to specific data fields, or queries based on specific data fields, for sending data to predetermined output destinations including; email recipients 20, folders in a file system 22, printers on a computer or network 24 and windows for display on the host systems display device.

An aspect of the invention is the ability to distribute the work or function of monitoring and executing Event Procedure 44 and Event Procedure Catalogs 40 across multiple servers. The distribution of work is optional, and can provide the ability to process Event Procedures 44 and Event Procedure Catalogs 40 more efficiently by reducing the amount of processing that an individual server may be required to perform. This distribution can be completed at different functional levels. One practical embodiment of the distribution would have a single server containing the Event Procedure Catalog Queue Manager 38 and, upon determining that a specific Event Procedure Catalog 40 is due to be executed, assign that Event Procedure Catalog 40 to another server. The Event Procedure Catalog Queue Manager 38 server would be responsible for assignment of Event Procedure Catalogs 40. Communication between the Event Procedure Catalog Queue Manager 38 server and the other servers might be done via a form of inter-computer messaging such as SOAP or XML or via writing records to a database to which the Event Procedure Catalog Queue Manager 38 server and individual servers which execute Event Procedure Catalogs 40 both have access. Other implementations of the invention might include optimizing the functionality by having separate servers: to process execution of scripts 42, to call the report engine 53 to create and format the reports 54, distribute the results to appropriate destinations including; email recipients 20, folders in a file system 22, printers on a computer or network 24 and windows for display on the host systems display device; and/or to provide the messaging and queuing to perform the interaction between the servers.

An aspect of the current invention is to have the ability to optimize the functioning of execution of Event Procedure Catalogs 40 and Event Procedures 44 based on metrics and a mathematical formula and weighting system. One or more of the multiple servers would assign values (“Weights”) to the Event Procedure Catalogs 40 and/or Event Procedures 44, and the distribution of the execution would be changed in response to evaluation of these values.

Objects and Processes

Having explained the general function of the system of the present invention, attention is now drawn to a specific detailed implementation of the objects that are used to define and operate the system. Instances of many of the objects have a definition that may be stored in the system database 48. In this detailed implementation, certain conventions are used.

In this detailed implementation the formatted report generation system, the report engine is provided using Crystal Decisions Crystal Reports® Print Engine (CRPE) API calls or Report Design Component (RDC) and creating wrappers to interface these components with the Event Procedures. These two report engines are tools which read a report template and allow modification of the specified report before formatting it and creating documents (reports) for output. The details of the properties of these components are described below. Storage of data for the system database is done using an Open Database Connectivity (ODBC) compliant data source (e.g. Microsoft Access or Microsoft SQL Server). Scripts are written in VBScript or JavaScript and handled by the Microsoft Scripting Control or in SQL and handled by Microsoft Active Data Objects with all programming objects written in Microsoft Visual Basic. User interface is written in Microsoft Visual Basic.

Event Procedure Catalog Queue Manager Object Functionality

In this detailed implementation of the invention, the Event Procedure Catalog Queue Manager 38 uses specific processes in order to perform the functions of evaluating when Event Procedure Catalogs 40 are to be executed. Referring to figure 3, the process starts at block 70 in the user interface (UI) where the user selects (represented by block 72) to begin monitoring and responding, which is the service mode 75. The Event Procedure Catalog Queue Manager 38 contains a timer 78 which runs on a periodic or regular interval In this detailed implementation 20 seconds was used. Upon completion of the passage of the interval of time, the mode is evaluated again (represented by decision block 82). If the mode is deemed to be service mode, the list of Event Procedure Catalogs' is read into a collection for evaluation (step 84). A loop 88 is done for each Event Procedure Catalog. The Event Procedure Catalog definition is read and the data element that represents whether the Event Procedure Catalog is enabled is checked for a value (block 90). Upon a True or Yes, the Event Procedure Catalog is evaluated to determine if it is due to run (block 92). This determination is made by comparing the current date and time to the start date and time as defined in the Event Procedure Catalog's definition. If the start date and time are passed, a comparison is made to the last run date plus the defined waiting period (e.g. 5 minutes, weekly, bi-weekly, last day of month) in the Event Procedure Catalog's definition. If the comparison determines that the last run date plus waiting period have passed, a check is made to determine if the day of the week is approved within the Event Procedure Catalog's definition. On satisfaction of all of these conditions, the Event Procedure Catalog is executed (block 94) by the appropriate server. In a single server environment, this would be the same as the Event Procedure Queue Manager. In a multi-server environment, this would be determined based on information such as a specific server designation or metrics as defined within the Event Procedure Catalog definition and/or one or more mathematical formulae to determine and assign the appropriate server. If any of the conditions are not met, the Event Procedure Catalog Queue Manager stops evaluating the current Event Procedure Catalog in the collection and continues to the next Event Procedure Catalog in the collection (block 96). This loop which began for each Event Procedure Catalog 88 is repeated until all Event Procedure Catalogs have been deemed due to run and executed 94 or deemed not due to run. The process begins again when the timer passes the pre-defined interval 98.

In the case where the user has changed the mode 82, User switches Mode 86 or 72 to maintenance, the processing of the Event Procedure Catalogs is stopped. This is done to allow changing of the definitions of the Event Procedure Catalogs and other metadata in the system without execution. When the system is in maintenance mode 77, the user can use the UI to make these changes User changes the definitions using User Interface (UI).

8080. The user can continue changing these definitions until they select 86 service mode 75, or until the select to exit 87 which halts all processing and terminates the instance of the system.

There is no data stored in the system database to represent the Event Procedure Catalog Queue Manager. It is a software process.

Event Procedure Catalog Object

Event Procedure Catalogs (FIG. 2 block 40) are used to determine the schedule of Event Procedures (FIG. 2 block 44), to group multiple Event Procedures to be executed together, and to determine notification of completion of Event Procedures with success or failure. Below is a table describing the “attributes” or detailed information which may be contained within each Event Procedure Catalog's definition retained in the system database. In all cases each attribute is a type of variable, and a collection of these variables strung together forms the complete object:

| Name | Type | Description |
|---|---|---|
| ID | Integer | Unique Identifier |
| Description | Text | Description of Event Procedure Catalog |
| ScheduleTpye | Integer | Number representing frequency to run |
| Schedule | Text | List of days of week to run |
| EventProcedure | Text | Time to start Event Procedure Catalog |
| BeginTime | | |
| EventProcedure | Date/ | Date to start Event Procedure Catalog |
| BeginDate | Time | |
| LastRan | Date/ | Date/Time of last execution of Event |
| | Time | Procedure Catalog |
| LastRanBy | Text | User Name of logged in user during last |
| | | execution |
| LastResult | Text | Result of last execution including |
| | | success or failure |
| Enabled | Yes/No | Flag for temporarily enabling/disabling |
| | | individual Event Procedure Catalog |
| NotifyOnSuccess | Yes/No | Flag to create an email when Event |
| | | Procedure Catalog is successful |
| NotifyOnFailure | Yes/No | Flag to create an email when Event |
| | | Procedure Catalog fails |
| NotifyEmailAddress | Text | Address to send notification email |
| EmailSubject | Text | Subject of email if combining multiple |
| | | Event Procedures to recipients |
| EmailBody | Text | Message body of email if combining |
| | | multiple Event Procedures to recipients |
| EventProcedure Test | Integer | Reference to Script to run as Pre-Event |
| | | Procedure Catalog Test |
| Post EventProcedure | Integer | Reference to Script to run as Post-Event |
| Action | | Procedure Catalog Action |
| TestCommandLine | Text | List of parameter values for Pre-Event |
| | | Procedure Catalog Script |
| ActionCommandLine | Text | List of parameter values for Post-Event |
| | | Procedure Catalog Script |
| Prior Duration | Time | Amount of time the prior execution took |
| | | to complete |
| PriorUniqueIDs | Integer | Number of Unique Identifiers or entities |
| | | in the database that were included in the |
| | | last run |
| TypeFactor | Text | Classification or Category used to |
| | | change the weighting in optimization |
| | | scheme |
| WeightedDuration | Time | A calculated number combining the |
| | | number of entities and the last execution |
| | | duration |
| PriorityFactor | Integer | Number used to decide priority when |
| | | assigning the weighting in optimization |
| | | scheme |
| LastLagTime | Time | Amount of time between the time the |
| | | Event Procedure Catalog became past |
| | | due and the time execution began |

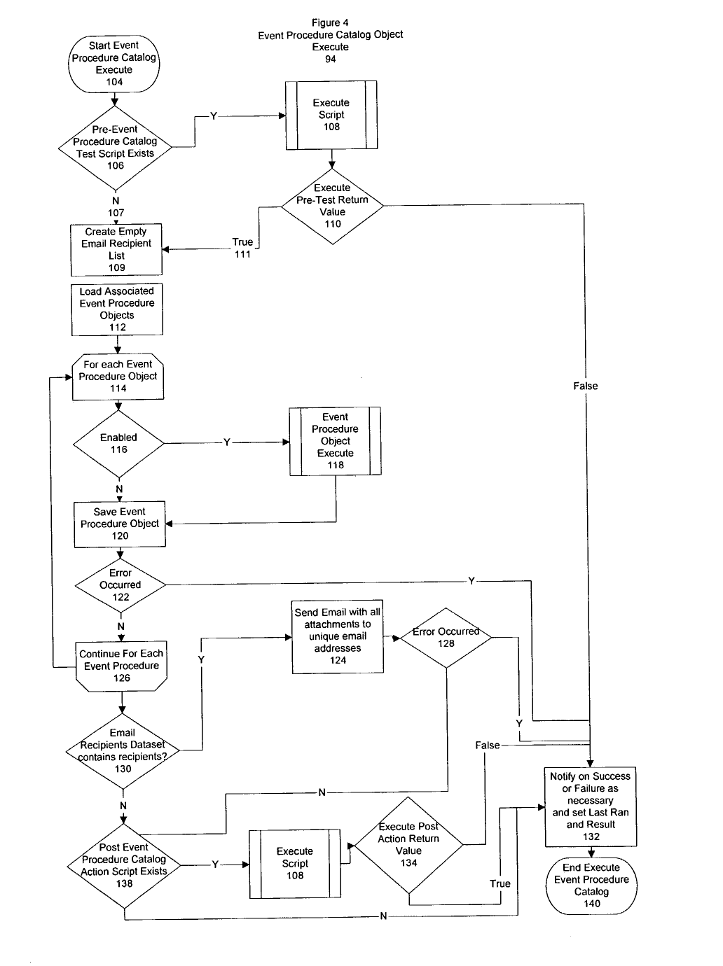

As defined in FIG. 4, this detailed implementation of the execute process of the Event Procedure Catalog begins (block 104) by checking for existence in the Event Procedure Catalog definition for a Pre-Event Procedure Catalog Test Script 106. Upon finding the existence of a Pre-Event Procedure Catalog Test script, the process must execute the script 108 and use the return value 110 to determine whether to continue executing the specific Event Procedure Catalog 111. These tests may include determining if certain data exists, has been created, modified, or deleted, or other conditions including checking of files on a network, querying web services for a result, or evaluating the result of prior actions taken and recorded by the system. Based on a False result of the Script (FIG. 2 block 42), the Event Procedure Catalog ceases execution, and updates the notification sent by the Event Procedure Catalog (FIG. 2 block 40) shown as step 132. Absence of a Pre-Event Procedure Catalog Test script 107 is treated with the same result as a true return value 111. The Event Procedure Catalog opens a dataset in memory to keep a list of unique recipient email addresses 109. The Event Procedure Catalog loads the collection of associated Event Procedures 112. A loop is started for each Event Procedure 114. The Event Procedure definition is read to determine whether it is enabled 116. If it is enabled, then the Event Procedure is executed 118 as described in more detail below in the Event Procedure Object Definition. The Event Procedure definition is saved 120, the error status is checked 122, and if the error status is “no error”, the loop continues 126 through all the related Event Procedures within the Event Procedure Catalog. Upon any error status other than “no error”, the results are saved 132, the loop of Event Procedures is exited and the execution of the Event Procedure Catalog is ended 140.

Once all Event Procedures have been processed, the dataset of email addresses is checked 130 for existence of recipients. If there are any recipients in the list, the emails are processed 124 and sent. The error status of the email is evaluated and if an error occurred 128 then the results are updated and notifications sent 132. If no errors occur in the email send the Event Procedure Catalog Object checks for existence in the Event Procedure Catalog definition for a Post-Event Procedure Catalog Action script 138. If the script exists, it is executed 108, the return value of the script is evaluated 134, and the Event Procedure Catalog Last Results and Last Ran are updated and notifications are sent 132. The execution of the Event Procedure Catalog ends (block 140) and control is passed back to the Event Procedure Catalog Queue Manager.

Event Procedure Object

In this detailed implementation Event Procedure objects are executed by Event Procedure Catalog objects. Their definitions are stored in the system database. Below is a table describing the “attributes” or detailed information which may be contained within each Event object retained in the system database. In all cases each attribute is a type of variable, and a collection of these variables strung together forms the complete object:

| Name | Type | Description |
|---|---|---|
| ID | Integer | Unique Identifier |
| AppID | Integer | Reference to Monitored Application for |
| | | Event Procedure |
| Event Procedure | Text | Report, Email-Only |
| Type | | |
| ReportFile | Text | Template file name for Report or Script |
| Description | Text | Textual Description |
| Mode | Integer | Active/Inactive/All as defined by |
| | | Special Metadata |
| SSN | Text | Unique Identifier of single data element |
| | | criteria as defined by Monitored |
| | | Application's Special Metadata |
| CriteriaForm | Text | Formula for selection criteria |
| CriteriaDesc | Text | English description of criteria |
| SortByForm | Text | Formula for sorting |
| GroupByForm | Text | Formula for grouping |
| GroupPageSkip | Yes/No | Yes to skip page after each new |
| | | grouping |
| Destination | Integer | Window, Printer, File or Email (0-3) |
| PrinterName | Text | Printer destination |
| SendAsEmail | Yes/No | Flag for Email Destination |
| EmailMode | Integer | Flag: address in [EmailAddress], |
| | | Related individual as summary, Related |
| | | individual as individual, each individual |
| | | as defined by Special Metadata |
| EmailAddrType | Text | For use when Monitored Application |
| | | Database contains multiple email |
| | | addresses |
| EmailSubject | Text | Subject text for email destination |
| EmailMessage | Text | Message Body Text for email |
| | | destination |
| ExportFormat | Integer | Number corresponding to output file |
| | | type |
| ExportPath | Text | Destination name for file destination |
| BeginDateForm | Text | Text put into report definition if it has a |
| | | BeginDate formula parameter |
| EndDateForm | Text | Text put into report definition if it has |
| | | an EndDate formula parameter |
| Code1Form | Text | Text put into report definition if it has a |
| | | Code1 formula parameter |
| Code2Form | Text | Text put into report definition if it has a |
| | | Code2 formula parameter |
| EventTest | Integer | Reference to unique identifier for Pre- |
| | | Event Procedure script |
| PostEventAction | Integer | Reference to unique identifier for Post |
| | | Event Procedure Action script |
| Enabled | Yes/No | Flag to temporarily enable/disable Event |
| ByIndividual | Yes/No | Flag to indicate for each person on the |
| | | report when sent to Related individuals |
| | | as defined by Monitored Application's |
| | | Special Metadata |
| EmailAddress | Text | List of recipient addresses for single |
| | | recipient |
| ByRelated individual | Yes/No | Flag to indicate creation of summary |
| | | reports when recipients are Related |
| | | individuals as defined by Monitored |
| | | Application's Special Metadata |
| RunForEach | Yes/No | Flag to indicate creation of separate |
| | | reports for each person on the report |
| | | when destination is Printer or File |
| EmailAttachment | Memo | List of files to attach to email when |
| | | destination is email |
| TestCommandLine | Text | List of parameter values for Pre-Event |
| | | Procedure script |
| ActionCommandLine | Text | List of parameter values for Post-Event |
| | | Procedure Action script |
| ReportEngineID | Integer | Number referencing ID of report engine |
| | | used to create the report |
| Prior Duration | Time | Amount of time the prior execution took |
| | | to complete |
| PriorUniqueIDs | Integer | Number of Unique Identifiers or entities |
| | | in the database that were included in the |
| | | last run |
| TypeFactor | Text | Classification or Category used to |
| | | change the weighting in optimization |
| | | scheme |
| WeightedDuration | Time | A calculated number combining the |
| | | number of entities and the last execution |
| | | duration |
| PriorityFactor | Integer | Number used to decide priority when |
| | | assigning the weighting in optimization |
| | | scheme |

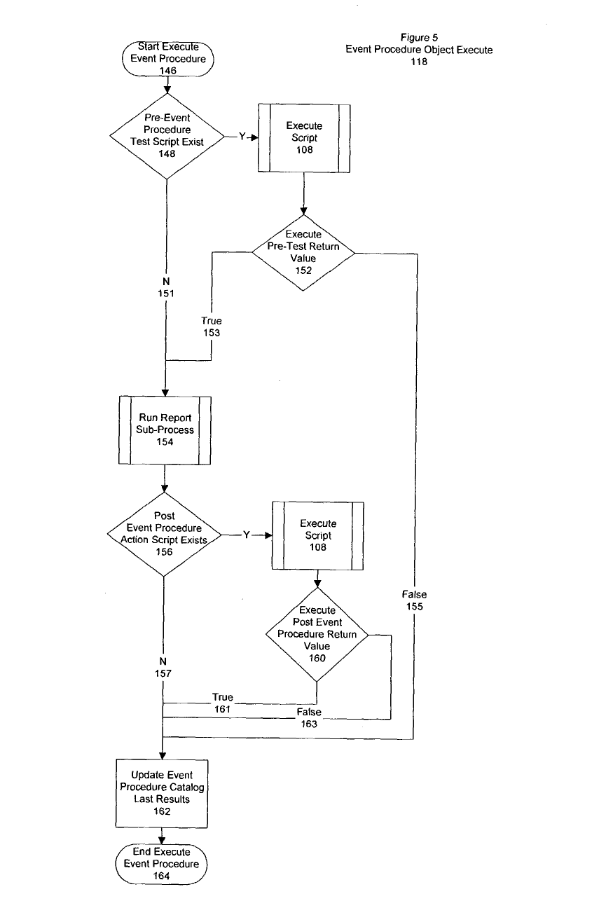

As shown in FIG. 5, this detailed implementation of the execution process for the Event Procedure object starts 146 by checking for existence in the Event Procedure definition for a Pre-Event Test Script 148. If a script is found to exist, the script is executed 108. Based on a False result of the Script 155, the Event Procedure exits updating the status to indicated having been skipped due to Pre-Event Condition Test result 162. With a True result 153 or absence of a Script 151. In other specific implementations, there may exist Event Procedures which do not perform the same reporting functionality and still remain as part of the Event Procedure Catalog. These alternate forms are not part of the present invention and do not affect the processing of the present Event Procedures. The alternate forms of Event Procedures might include Event Procedures whose sole purpose is to execute a script, a command line or other process. Event Type in the definition of the Event Procedure is used to distinguish between the Event Procedures with differing purpose or process. In this detailed implementation, Event Type is limited to the case of a Report or Email-Only, and the Event Procedure calls the Run Report sub-process 154 which is described in more detail below. Upon completion of the running of the report, the Event Procedure definition is checked 156 for the existence of a Post-Event Procedure Action script. If there is a reference to an action script, it is executed 108 and the result is evaluated 160. Based on a False result of the script 163, the Event Procedure updates the status to indicated having failed due to an error in the Post-Event Procedure Action script 162 and exits 164. In the absence of a Post-Event Procedure Action script reference 157, or if the referenced script returns a True value 161, the Event Procedure updates the status to reflect success 162 and exits 164.

Run Report Sub-Process

The opening, setup, execution and distribution of reports is done via a process herein defined as the Run Report sub-process. This process is called by the Event Procedure objects. In this detailed implementation of the invention the Run Report sub-process uses Crystal Decisions Crystal Reports® to create the formatted output from the Monitored Application Database.

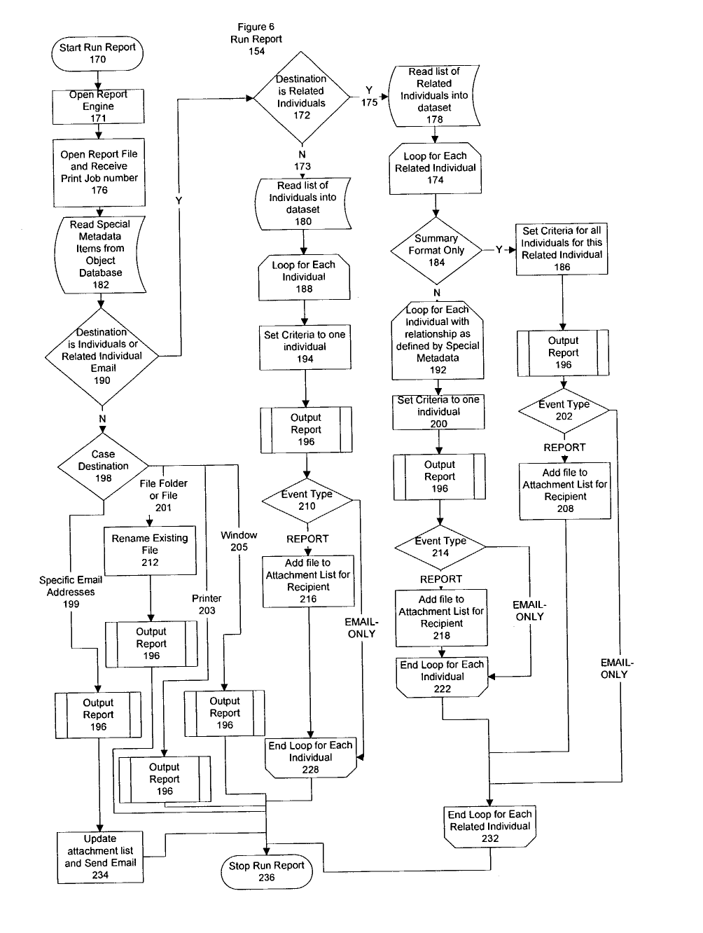

A brief overview of the process in this detailed implementation as described in FIG. 6 is that the sub-process begins (block 170) by initializing the report engine 171 to be run. In the case of Crystal Reports Report Design Component, this involves instantiating the object. The report is opened by passing the file name to the report engine 176 and a unique job number is assigned by the report engine. Variables are read and set to determine: the SQL statement that the report uses to extract the data, the grouping that the report has, the sorting that the report has, the selection formula (criteria) that the report has, and any custom parameters that the report contains. The report is generated once or multiple times determined by the destination and number of recipients. If the destination is File or Email then report is saved to the file system. If the destination is Printer or Window it is generated to the destination but not stored for distribution or retrieval. The status of the report is passed back to the Event Procedure that called it.

More detailed explanation of the Run Report sub-process is described using FIG. 5. The Run Report sub-process is started 170 by opening a specific report engine as specified in the Event Procedure definition ReportEngineID 171. The report engine opens the report template and returns a number for the specific instance of the report 176, the specific instance being referred to as the “print job”. This number is unique for each print job that the apparatus executes from the time it is started through the time that the apparatus is closed. The uniqueness of this number is important to differentiate the resulting output from one another at the time of distribution. This number, the “job number,” is used by the Run Report sub-process in the file name as a differentiator between multiple copies of the same report being stored to a specific file destination or temporary folder. An aspect of the present invention is customization of the formatted presentation reports. A benefit of this aspect is to provide the ability to reuse report templates for multiple Event Procedures and generate the desired formatting and data without redesigning the template. The Run Report sub-process then retrieves from the system database a collection of Special Metadata 182, which identifies the criteria of records that the report will contain, the grouping of data on the report, the sorting of data on the report, the destination or destinations for the report and any optional parameters required by the report engine in order to adequately create and distribute the print job. The exact details of Special Metadata used will vary amongst different implementations of the invention depending on the customization that the implementation provides for the reports and distribution. A detailed list of these Special Metadata items for this detailed implementation is included below.

The process then determines from the Event Procedure definition if the report will be distributed via email to individuals based on the content of the report, or to individuals with a specific relationship as defined in the Special Metadata to the content of the report 190. If neither of these is the case 198, the Run Report sub-process next determines from the Event Procedure definition to what type of destination the report will be output. In the case of a specific email address 199, the Output Report sub-process is called 196, as defined below to invoke the report engine and create the necessary file to be emailed from the print job. The recipient email address and file name are added to the Event Procedure Catalog's email recipient list 234 created in prior step 109. The Run Report sub-process then exits 236. In the case where the destination is determined 198 to be a file folder or file 201, the process checks for the existence of any existing file and renames it to some other name 212, the Output Report sub-process is called 196, as defined below to invoke the report engine and create the necessary file to be saved to the file system. The Run Report sub-process then exits 236. In the case where the destination is determined 198 to be a printer 203, the Output Report sub-process is called 196, as defined below to invoke the report engine and generate the report directly to the printer designated in the Event Procedure definition. The Run Report sub-process then exits 236. In the case where the destination is determined 198 to be a window 205, the Output Report sub-process is called 196, as defined below to invoke the report engine and create the necessary report and display it to a window on the host device. This option is most useful for the testing of the Run Report sub-process. The Run Report sub-process then exits 236.

If the process determines from the Event Procedure definition if the report will be distributed via email to individuals based on the content of the report, or to individuals with a specific relationship as defined in the Special Metadata to the content of the report 190, the further determination is made if the report will be distributed via email to related individuals based on the content of the report 172. If not 173 then a dataset is created by extracting the list of individual unique identifiers from the definition for the report contents via the report engine 180. In this detailed implementation this step is performed by reading the SQL Query from the report and creating a dataset using the “From” and “Where” clause with a direct connection to the Monitored Application database and Related Email Destination Database. A loop is started for each individual unique identifier in the data set 188. The criteria of the report is set to only the individual unique identifier 194, the Output Report sub-process is called 196, as defined below to invoke the report engine and create the necessary file to be emailed from the print job. The Event Procedure type is determined from the Event Procedure definition 210. If the Event Procedure type is Email-Only, then the actual report file is not to be sent with the cover email and was only generated for the purpose of identifying the list of recipients, and the loop continues to the next individual. If the Event Procedure type is Report, the recipient email address and file name are added to the Event Procedure Catalog's email recipient list 216 created in prior step 109. The loop continues for each individual 228. When the loop is completed the Run Report sub-process exits 236.

If the further determination is made if the report will be distributed via email to related individuals based on the content of the report 172 175, then a dataset is created by extracting the list of individual unique identifiers from the definition for the report contents via the report engine 178 and the list of Related Individual email addresses is extracted from the Related Email Destination Database. In this detailed implementation this step is performed by reading the SQL Query from the report and creating a dataset of email addresses using the “From” and “Where” clause with a direct connection to the Monitored Application database and Related Email Destination Database. A loop is done for each of the Related Individuals in the dataset 174. It is determined if the Event Procedure is defined to produce a Summary format only according to the Event Procedure definition Summary Format Only 184. If not, a loop is started for each Related Individual unique identifier in the data set 192. The criteria of the report is set one of the records with the relationship specified in the Special Metadata and identified in the destination information of the Event Procedure as being the Related Individual 200, the Output Report sub-process is called 196, as defined below to invoke the report engine and create the necessary file to be emailed from the print job. The Event Procedure type is determined from the Event Procedure definition 214. If the Event Procedure type is Email-Only, then the actual report file is not to be sent with the cover email and was only generated for the purpose of identifying the list of recipients, and the loop continues for each individual identified in the destination information of the Event Procedure as being the Related Individual 222. If the Event Procedure type is Report, the recipient email address for the Related Individual and file name are added to the Event Procedure Catalog's email recipient list 218 created in prior step 109 and the loop continues for each individual identified in the destination information of the Event Procedure as being the Related Individual 222. When the loop is completed the loop continues for each Related Individual 232. When the loop is completed the Run Report sub-process exits 236. If the Event Procedure is defined to produce a Summary format only according to the Event Procedure definition Summary Format Only 184, the criteria of the report is set to only the records with the relationship specified in the Special Metadata and identified in the destination information of the Event Procedure as being the Related Individual 186, the Output Report sub-process is called 196, as defined below to invoke the report engine and create the necessary file to be emailed from the print job. The Event Procedure type is determined from the Event Procedure definition 202. If the Event Procedure type is Email-Only, then the actual report file is not to be sent with the cover email and was only generated for the purpose of identifying the list of recipients, and the loop continues for each Related Individual 232. If the Event Procedure type is Report, the recipient email address for the Related Individual and file name are added to the Event Procedure Catalog's email recipient list 208 created in prior step 109. The loop continues for each Related Individual 232. When the loop is completed the Run Report sub-process exits 236.

Specific implementations of the invention might include sending a report to a list of recipients on the report (branch starting at 180) such as a list of employees, sending a report to a list of recipients with a Related Individual relationship to the people on the report (branch starting at 178) like the supervisors of employees, or sending the report to a list of recipients designated to receive information about a specific entity on the report such as a GL account or zip code.

Output Report Sub-Process

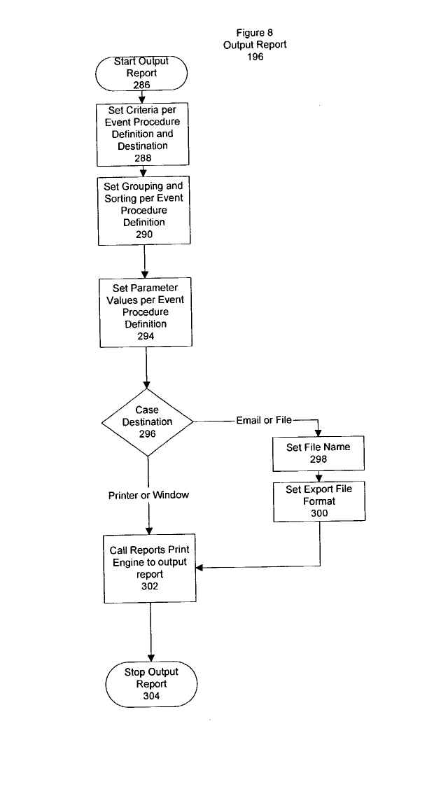

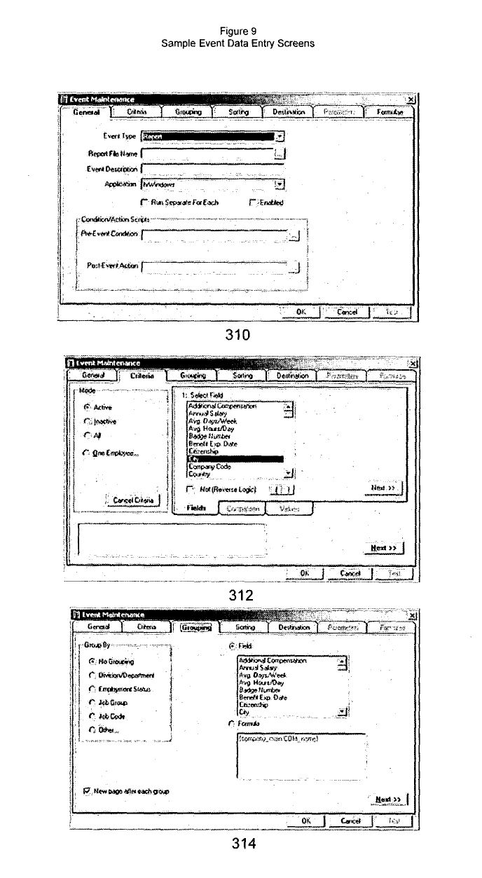

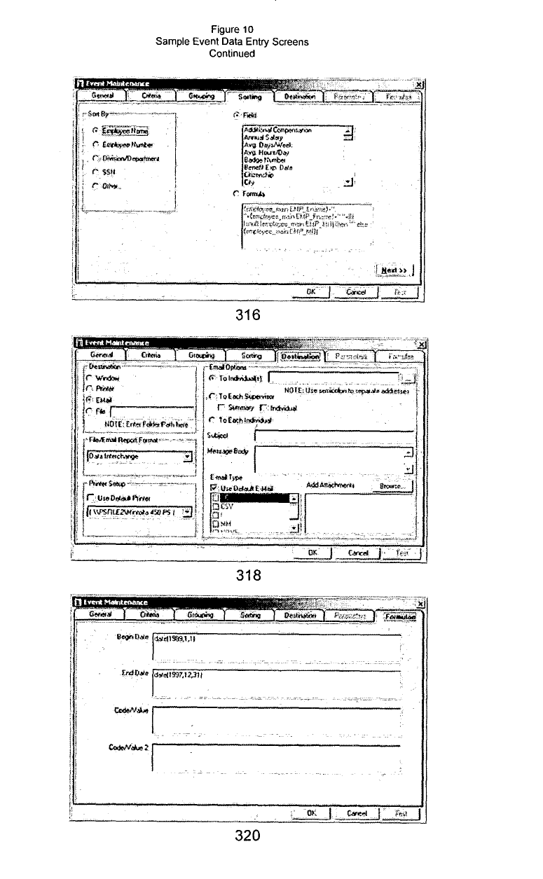

The Output Report sub-process, as shown in FIG. 8, is used by the Run-Report sub-process to configure the print job before creating it by connecting it to the data and retrieving and formatting the data according to the template and Special Metadata specification. The Output Report sub-process begins (block 286) when is invoked by the Run-Report sub-process. The call from Run-Report includes the Event Procedure definition which contains the Monitored Application Database Definitional Metadata and Special Metadata required to configure the print job from the report template. The criteria which defines what data to include and what filter to apply when retrieving records is set for the individual print job 288. The grouping of data on the report and sorting of data on the report are set if they are specified in the Event Procedure 290. If the print job required any optional parameters which may be used to help format the report, these are set 294. These parameters might include dates used for date ranges in the report, specific values that the report prompts for at runtime or other information that is configurable every time the report template is used. The destination of the report is determined from the Event Procedure definition 296. If the destination is email or file, the file name is set 298 and the file format is set 300 for the Report Engine specified in the Event Procedure definition. The print job is run by invoking the appropriate Print Engine calls 302. The Output Report sub-process ends (block 304).

Pre-Event Procedure Condition Test Scripts, Pre-Event Procedure Catalog Condition Test Scripts, Post Event Procedure Action Scripts and Post Event Procedure Catalog Action Scripts—Scripts

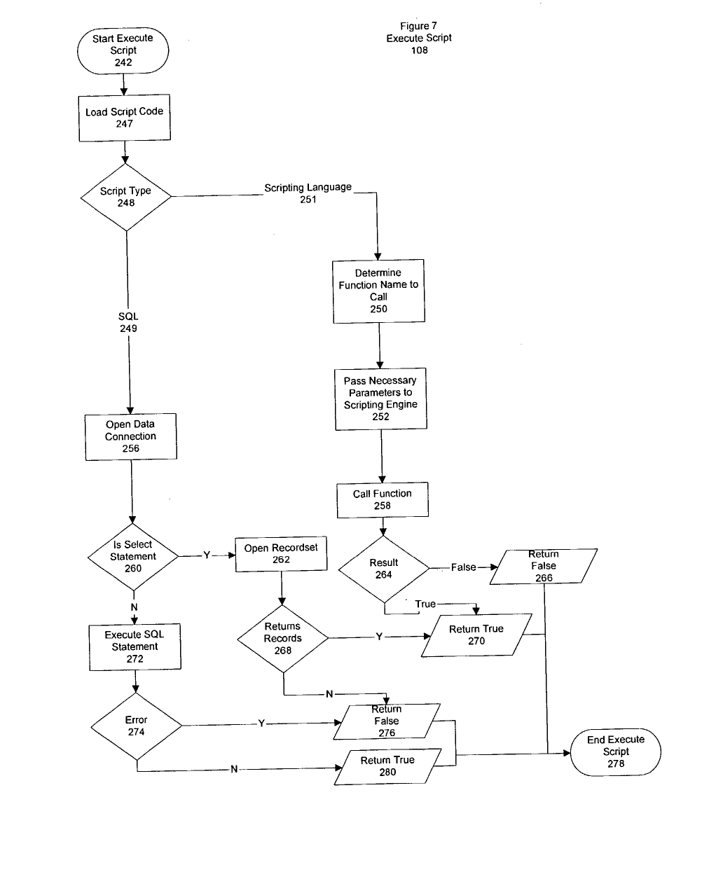

Scripts are used to perform testing for specific conditions internal or external to the monitored application database, and to perform actions as defined by the Event Procedure Catalog or Event Procedure that called them. In this detailed implementation, when performing a test, the script object returns a boolean value representative of True or False to indicate the result. The scripts are stored in the file system as a text file, or in the System Database. The scripts may be encrypted to provide security against modification or examination by unauthorized users. The scripting languages VBScript and JavaScript and the query language SQL were used to define the tests and actions. The process of the script execution is described in conjunction with FIG. 7. The script starts the Execute process 242 by loading its object code 247 and determining the Script Type 248 as defined in the scripts definition. In this detailed implementation the Script Types are “SQL” or “Scripting Language” (VBScript or JavaScript). Other implementations may use other tools or languages to perform testing and actions when functioning such as Python or Microsoft C#®. In the case of a SQL Script Type 249, a dataset is opened against the Monitored Application Database 256. The text of the SQL statement is analyzed to determine if it is a select statement 260, if so, the SQL is executed 262 and the resulting recordset is tested to determine if any records where returned 268. If the record count is greater than zero, a True value is returned 270. If the recordset returns no records, a False value is returned 276. In the case where the SQL Statement is determined not to be a select statement 260, the SQL Statement is executed. The error state is checked to determine whether to return a True value 280 or a False Value 276. Upon completing the return value the script execution ends (block 278). If the Script Type is is determined to be a scripting language 251, the function name is determined based on the call made to the script execution routine from the Event Procedure or the Event Procedure Catalog 250. If any parameters were specified for the script, these are also processed 252. The function is called including the passing of the parameters 258. In this detailed implementation the function calls are made by adding the script code to a Microsoft® Script Control and using the .Eval function to make the procedure call with the paramters and get a return value. In other implementations the scripting functions could be evaluated using operating system components, third-party script engines, browsers script evaluation or other means. The return value is returned 264 and passed as the return value for the script back to the calling Event Procedure or Event Procedure Catalog 266 or 270. Upon completing the return value the script execution ends (block 278). In this detailed implementation script parameters include User ID and Password for the monitored application database in order for the Script to make an independent connection to the monitored application database. A feature of this implementation is that the script object code can be used for multiple purposes by allowing the Event or Event Procedure Catalog to pass a command line of parameters for the Script to process. An example of this flexibility would be to have a Script that connected to the monitored application database and returned a True if there were any records that match a criteria for a specific date range. Different Event Procedures and/or Event Procedure Catalogs could use the same script passing different date ranges, allowing reuse of the same script for similar tests without creating separate object code for each possible variation. Other detailed implementations might not require parameters pass to the Script. The scripts capabilities are limited only by the scripting language used and the capabilities of the server from which they are executed. Scripts can be run to open and evaluate datasets, read and write files from the file system or network, interact with other systems or applications, utilize communications such as web services or http protocol to interact with external systems or other scriptable functions. These capabilities allow conditions to be evaluated in separate systems than the Monitored Application.

Monitored Applications

In this detailed implementation, Monitored Application definitions 6 are the collection of metadata 49 which are used to define separate Monitored Application Databases 8. Their definition is stored in the System Database 48. Below is a table describing the “attributes” or detailed information that may be contained within each Monitored Application object 6 retained in the system database. In all cases each attribute is a type of variable, and a collection of these variables strung together forms the complete object: Monitored Application Connection Metadata:

| Name | Type | Description |
|---|---|---|
| AppID | Long Integer | Unique Identifier |
| AppName | Text | Description of Application or |
| | | Monitored Application Database |
| Database | Text | Name of database file if Monitored |
| | | Application Database is file |
| | | database |
| ConnectString | Text | Connection String to open |
| | | Monitored Application Database |
| ConnectStringEmail | Text | Connection String to open Related |
| | | Email Destination Database if |
| | | different from Monitored |
| | | Application Database |
| DefaultReport | Text | Filename of report template to use if |
| | | sending email without attached |
| | | report and using report for |
| | | generation of recipient list only. |

In this detailed implementation of the invention, Monitored Application objects 6 are used to differentiate among separate monitored application databases 8 for which Event Procedures 44 are defined. An aspect of the invention is having destination information reference specific fields or queries based on specific fields in a database other than the Monitored Application Database 8. This separate database is called the Related Email Destination Database 56. The Monitored Application definition 6 contains information used to connect to the Monitored Application Database 8 and Related Email Destination Database 56 to retrieve the values for the Special Metadata items. The Monitored Application definition 6 also contains a reference to a report template to be used for the building of criteria for the Event Procedures 44 with an Email-Only Event Type.

Other metadata used to define the Monitored Application Database 8 describes each of the fields that the user can use for defining the customizations made to the Report 54 when it is created during the Output Report sub-process 196. This metadata provides the User Interface a method to display descriptions which represent the field contents and eliminate the need for the user to know the exact field names. An example of this would be a metadata item that contains the reference to a field named “JOB_EFFDTE” and a description of “Job Effective Date.” The user can be presented with a list of descriptions for the purpose of deciding how to customize the report including on which field or fields to group, sort and filter the data, instead of being presented with a list of table and field names which requires more technical knowledge of the Monitored Application Database definition 8. Below is a table describing the “attributes” or detailed information that may be contained within each Monitored Application Database Definitional Metadata retained in the system database. In all cases each attribute is a type of variable, and a collection of these variables strung together forms the complete object: Monitored Application Database Definitional Metadata:

| Name | Type | Description |
|---|---|---|
| MD_ID | Long Integer | Unique Identifier |
| AppID | Integer | Reference to Monitored Application |
| | | Database being described |
| MD_Table | Text | Name of database table |
| MD_Field | Text | Name of database field |
| MD_Description | Text | Plain language description for |
| | | display in User Interface |
| MD_FieldType | Integer | Type of field to allow UI to properly |
| | | translate values |
| MD_FieldSize | Integer | Size of field to allow UI to properly |
| | | display values |

User Security

Information defining authorized users of the apparatus is stored in the System Database. This Metadata allows the apparatus to provide security for the System Database 48, and to provide security information to access the Monitored Application Database(s) 8. This information includes variables which represent the Name, UserID and Password in addition to information about which Event Procedure Catalogs 40, Event Procedures 44, Monitored Applications 6 and scripts the user is allowed to access.

Special Metadata

The system uses identifiers in the form of metadata to represent certain pieces of data contained in the monitored application database or related email destination database. The use of metadata to define the structure of the database enables the system to be used for multiple databases, whether simultaneously or as separate implementations. Using this method, the system can be configured and reused for multiple Monitored Application Databases 8 without rebuilding the code or re-defining its relationships. These Special Metadata items are stored in the system database 48. Below is a table describing the “attributes” or detailed information that may be contained within each Special Metadata object retained in the system database 48. In all cases each attribute is a type of variable, and a collection of these variables strung together forms the complete object:

| Name | Type | Description |
|---|---|---|
| PK | Integer | Unique Identifier |
| AppID | Integer | Reference to Applications Object for which this |
| | | Metadata is to be used |
| Entity | Text | Table Name in Monitored application database to |
| | | located values if stored in useable format |
| FieldName | Text | Field Name in Monitored application database to |
| | | located values if stored in useable format |
| SQL | Memo | SQL Statement to return value of Metadata |
| | | enabling the manipulation of the value before it is |
| | | passed to the system- |

The use of these Special Metadata items enables certain aspects of the system to be reconfigured to reference information in the monitored application database which differs from this implementation of the invention. As an example, there exists a Special Metadata item to describe the location and field in the Monitored Application Database 8 that represents the “Department” to which the person belongs. If the Monitored Application Database 8 is a sales contact application, this Special Metadata item might be redirected to a field which represents the “Sales Region” in which the prospect person is located. In the case where this Special Metadata is changed, the original functionality remains in place. In this specific example, the system could now group and sort reports based on “Sales Region” instead of “Department.” In this detailed implementation of the invention, the following Special Metadata items are stored in the database:

| Special Metadata Name | Information Returned |
|---|---|
| EMAILTYPE | Recordset including types of email addresses |
| EMPFNAME | First name of Person |
| EMPLNAME | Last name of Person |
| EMPMNAME | Middle initial of Person |
| ACTIVE | Value to indicate active status |
| INACTIVE | Value to indicate inactive status |
| LOOKUP | Recordset of names and unique identifiers of all |
| | People |
| SSNLOOKUP | Recordset of unique identifiers appended to |
| | names of all People |
| SSN | Value of Unique Identifier for Person |
| LOOKUPDIRECT | Recordset of names and unique identifiers for |
| | direct reports of a specific Person |
| SSNLOOKUPDIRECT | Recordset of unique identifiers appended to |
| | names of for direct reports of a specific Person |
| LISTSPVPE | Recordset of names, unique identifiers and |
| | fields used for sorting for direct reports of a |
| | specific Person |
| LISTSPVDIR | Recordset of distinct list of related individual |
| | unique identifiers for all People |
| LISTEMPBYSPV | Recordset of names and unique identifiers for |
| | direct reports for all related individuals |
| JOBSPV | Value for related individual unique identifier |
| | for a specific person |
| SPVEMLNAME | Value for email address and name of a specific |
| | Person |
| EMLDEFAULT | Value to identify default email address for a |
| | specific Person |
| EMLSERVICETYPEID | Value to identify email address type of a |
| | specific Person |
| COMPANYNAME | Value for Company Name for a specific Person |
| | used as a no grouping option as all People have |
| | the same value |
| EMPNUMBER | Value of employee number for a specific |
| | Person |
| JOBDIVCD | Value of Division Code for a specific Person |
| JOBDEPTCD | Value of Department Code for a specific |
| | Person |
| JOBSTATUSCD | Value of Job Status for a specific Person |
| JOBGROUPCD | Value of Job Group for a specific Person |
| JOBVALID | Value of Job Code for a specific Person |
| CTDIVDESC | Value of Division Description for a specific |
| | Person |
| CTDEPTDESC | Value of Department Description for a specific |
| | Person |

User Interface

An aspect of the current invention is in a system having at least one external monitored application database 8 identified therein, wherein the monitored application database 8 contains data to be tested for predetermined conditions: the method of creating identifiers including database identifiers for information relating to connection to the monitored application database, metadata for predetermined references to specific data fields, or queries based on specific data fields, within the monitored application database 8 for enabling the customization of the reports 54, and destination identifiers for references to specific data fields, or queries based on specific data fields, for sending data to predetermined output destinations. In this detailed implementation of the invention, the creation of said identifiers is done using a User Interface which is a software mechanism that loads the metadata 49 from the system database 48 and presents them to the user for modification 80. This is done using an 3-tier architecture whereby the system database 48 is opened and read by a software mechanism which passes the information to a separate software mechanism for display and manipulation by the user. This detailed implementation uses Microsoft Visual Basic for the creation of the user interface. Other specific implementations might use web-browser compatible interfaces or direct access to the data wherein the metadata is stored. The user is able to create new metadata and modify or delete existing metadata.

Optimization and Multiple Servers

An aspect of the current invention is the ability to distribute the work of the system across multiple servers 9. One method of this distribution might be done using separate servers for specific functions. This might include the Event Procedure Catalog Queue Manager's 38 evaluation of past due Event Procedure Catalogs 40, the execution of Scripts 42, the creation of Reports 54, the distribution of reports, the email functionality, the hosting of the client administrative application (if using a browser based interface) and the coordination of multiple servers. An alternative method would be to allow each server to act independently, sharing the system database 48, and each be responsible for a specific set of Event Procedure Catalogs 40. This detailed implementation uses a combination of the two methods by having a single Master Event Procedure Catalog Server which assigns Event Procedure Catalogs to be executed completely by specific Execution Servers. The Execution Servers are responsible for the execution of Scripts, the creation of Reports and the distribution of reports.

An aspect of the current invention is to have the ability to optimize the functioning of execution of Event Procedure Catalogs and Event Procedures based on metrics and a mathematical formula and weighting system. One or more servers 9 might assign values (“Weights”) to the Event Procedure Catalogs Event Procedure Catalog Processes 40 and or Event Procedures Event Procedure Processes 44 and the distribution of the execution would be changed in response to evaluation of these values. In this detailed implementation of the system the weights are Prior Duration, PriorUniquelDs, TypeFactor, WeightedDuration, LastLagTime and PriorityFactor. The Event Procedure Catalog Queue Manager analyses these weights and makes decisions about whether or not to execute a Event Procedure Catalog Event Procedure Catalog Processes 40, and in which order to execute the Event Procedure Catalogs Event Procedure Catalog Processes 40 based on the result of the analysis. The analysis might be done using a fixed formula, or might be configurable by the administrator of the system. Such configuration might include using Optimization Schemes for deciding the order. These Optimization Schemes might include: “Complete the Most Event Procedures” which would move Event Procedure Catalogs with smaller prior durations to the top of the queue, “In Order” which would queue them according to the date and time that they became past due, “Even Load Servers” which would spread the Event Procedure Catalogs across multiple servers based on free resources and Event Procedure Catalog Weights, “Threshold Load Servers” which would give some servers only Event Procedure Catalogs that are above or below a pre-defined threshold. Many other Schemes are possible. In this detailed implementation of the system the “In Order” Optimization Scheme was used.

The mathematical formula used to determine a Event Procedure Catalog's Weight can vary based on the desired Optimization Scheme. An example of a formula would be to take the PriorDuration divided be the PriorUniquelDs to get a weighted average of time per entity on the report. The Priority Factor could then be divided by the weighted average creating a number (Weight) which is larger for higher priority shorter execution Event Procedure Catalogs. At the time that any Event Procedure Catalogs Event Procedure Catalog Processes 40 are past due, the Weight of all pending Event Procedure Catalogs Event Procedure Catalog Processes 40 could be sorted and assigned or queued. More sophisticated implementations of the invention might automate the process of re-assigning priority or which server a Event Procedure Catalog Event Procedure Catalog Processes 40 is to be queued on based on a running history of the LastLagTime and the Weight.

System Summary

The above-described system includes many features which, although possibly available individually in other shared-data systems, act together within the system of the present invention to yield an unusually flexible service to its users. Of the many features of the invention, some of the most significant are: 1) the ability to monitor a monitored application database from an external system based on a set of metadata which defines the monitored application database; 2) the ability to distribute formatted reports which may contain data from the monitored application database to one or more recipients; 3) the ability to execute scripts which can review and manipulate the data and file system and 4) the capability to determine the recipients based on the data contained in the report, the metadata items and optionally the relationship between the data on the report and a separate database of email information.

These four features of the present invention synergize. The fact that the system remains external and the monitored application database retains its own structure and individual access rights means that each monitored application database can continue to be maintained by the administrator, system or user by whom it is already maintained. The capability to define the monitored application database using metadata enables the system to be used on multiple monitored application databases without the need to rebuild the object code. In addition, the metadata enables the system to dynamically change the output of a given report template including the criteria, grouping and/or sorting of the report. The capability to take the reports, as summoned by the database monitoring and configured using the metadata and distribute them to multiple destinations which may include recipients based on the data contained within the report's dataset means that the system can put the newly created information in the proper location without the need for manual intervention. The use of a scripting language enables the automation of testing, data review, data manipulation and file system actions.

While the invention has been described with reference to the structure disclosed, it is not confined to the details set forth, but is intended to cover such modifications or changes as may come within the scope of the following claims.

1. A computer implemented system for monitoring an external database comprising:
a server having a system database and a user interface coupled thereto, said server being connectable with an external database, said external database having data stored therein to be monitored;
said system database having metadata stored therein related to the external database and said monitoring thereof; and
wherein said server includes an executable program for evaluating said data stored in said external database based on information derived from said metadata.

2. The system as defined in claim 1 wherein said metadata is user defined.

3. The system as defined in claim 1 wherein said server includes a report engine for generating reports based on the results of said evaluations.

4. The system as defined in claim 1 wherein said executable program further comprises an event procedure object, said event procedure object being executable for evaluating said data stored in said external database.

5. The system as defined in claim 4 wherein said event procedure object further comprises data stored in said system database.

6. The system as defined in claim 5 wherein said evaluations performed by said event procedure object include testing for the occurrence of predefined conditions of said stored data.

7. The system as defined in claim 4 wherein said evaluations performed by said event procedure object include testing for the occurrence of predefined conditions of at least one of said stored data, said system database, said server, and an external system or application connected to said server.

8. The system as defined in claim 5 wherein said event procedure object further comprises priority information for prioritizing the execution of said event procedure object.

9. The system as defined in claim 5 wherein said event procedure object further comprises one or more scripts defining actions to be performed in conjunction with the execution of said event procedure object.

10. The system as defined in claim 9 wherein said scripts define actions for modifying the stored data in said external database.

11. The system as defined in claim 9 wherein said one or more scripts further comprise a predefined scripting language.

12. The system as defined in claim 9 wherein said one or more scripts are user definable.

13. The system as defined in claim 6 further comprising a report engine accessible to said event procedure object for generating reports based on at least one of said stored data, said evaluations, and the results of said evaluations.

14. The system as defined in claim 13 wherein said event procedure objects forward said reports to predetermined destinations.

15. The system as defined in claim 5 wherein said event procedure object sends information to predetermined destinations.

16. The system as defined in claim 13 wherein said report engine-determines appropriate destinations for said reports based on an evaluation of the content of said report.

17. The system as defined in claim 16 wherein said event procedure object forwards said reports to said destinations.

18. The system as defined in claim 16 further comprising an email database coupled to said report engine for storing email addresses of at least a portion of said destinations.

19. The system as defined in claim 16 wherein said destinations include at least one of an email recipient, a file recipient, a client recipient, and a printer recipient.

20. The system as defined in claim 14 further comprising an output report application coupled to said report engine, said output report application being executable for formating said reports based on information derived from at least one of said stored data, said metadata, said evaluations and the results of said evaluations.

21. The system as defined in claim 14 wherein said reports are formatted based on the destination thereof.

22. The system as defined in claim 5 further comprising a plurality of external databases wherein said system includes a plurality of said event procedure objects stored in said system database wherein each of said event procedure objects corresponds to one of said plurality of external databases.

23. The system as defined in claim 5 wherein the event procedure object includes frequency information for determining the frequency for the execution thereof.

24. The system as defined in claim 5 wherein the event procedure object includes frequency information for determining the frequency for the execution thereof.

25. The system as defined in claim 16 further comprising an event procedure catalog object coupled to said system database and said report engine, said event procedure catalog including data stored in said system database and an executable program for performing at least one of:
reading a plurality of said event procedure objects;
grouping a plurality of said event procedure objects, for scheduling the execution thereof;
executing said event procedure objects; and
generating notifications as to a completion or a failure of the execution of said event procedure objects

26. The system as defined in claim 16 further comprising an event procedure catalog object coupled to said system database and said report engine, said event procedure catalog including data stored in said system database and an executable program for performing at least one of:
reading a plurality of said event procedure objects;
grouping a plurality of said event procedure objects, for scheduling the execution thereof;
executing said event procedure objects; and
determining which of said reports have a common destination;

27. The system as defined in claim 26 further comprising an executable program for grouping said reports having a common destination for aggregate delivery thereof.

28. The system as defined in claim 25 wherein said event procedure catalog object includes frequency information for determining the frequency for the execution of said event procedure objects.

29. The system as defined in claim 5 wherein said event procedure object includes frequency information for determining the frequency for the execution of said event procedure objects.

30. The system as defined in claim 25 further comprising a manager application having a timer, the manager application including a service mode wherein a plurality of the event procedure catalog objects are retrieved and executed at predetermined intervals in accordance with said timer.

31. The system as defined in claim 30 wherein said manager application further comprises a user controlled maintenance mode wherein the execution of said event procedure catalog objects is suspended for user updating of said metadata.

32. The system as defined in claim 1 wherein the system is scalable.

33. The system as defined in claim 3 wherein the system further comprises a plurality of connectable servers for monitoring one or more external databases in a distributed system.

34. The system as defined in claim 33 wherein at least one of said plurality of servers is designated for performing a specific function of said system.

35. The system as defined in claim 25 wherein said system further comprises a plurality of connectable servers for monitoring one or more external databases, said plurality of servers being configured for optimizing the execution of said event procedure objects and said event procedure catalog objects.

36. The system of claim 35 wherein said system further comprises an optimization scheme for optimizing the execution of at least one of said event procedure objects and said event procedure catalog objects wherein said optimization scheme utilizes at least one of a metric, a mathematical formula and a weighting system.

37. The system of claim 1 wherein said system further comprises said server being connectable with an external database through a network.

38. A method for monitoring an external database comprising the steps of:
coupling a server to an external database having data stored therein to be monitored;
providing metadata accessible to said server, said metadata being related to said external database and the monitoring thereof;
accessing at least a portion of said stored data; and
evaluating said stored data based on said metadata.

39. The method for monitoring an external database as defined in claim 38 further comprising a step of generating a report based on at least one of said metadata and the results of said evaluations.

40. The method for monitoring an external database as defined in claim 39 further comprising a step of forwarding said report to at least one destination.

41. The method for monitoring an external database as defined in claim 39 further comprising a step of determining said at least one destination for said report based on at least one of said evaluations and the content of said report.

42. The method for monitoring an external database as defined in claim 40 further comprising a step of determining said destination for said report, wherein said step of determining includes comparing an email database content with the content of said report.

43. The method for monitoring an external database as defined in claim 40 further comprising a step of formatting said report prior to said step of forwarding.

44. The method for monitoring an external database as defined in claim 43 wherein said step of formatting of said report includes a step of determining a format for said report based on at least one of said metadata, the results of said evaluations and the destination for said report.

45. The method for monitoring an external database as defined in claim 38 wherein said step of coupling includes said server being connectable to a plurality of external databases to be monitored and wherein said step of providing metadata includes providing an event procedure object corresponding to each of said plurality of external databases.

46. The method for monitoring an external database as defined in claim 45 further comprising a step of defining said event procedure objects via a user interface.

47. The method for monitoring an external database as defined in claim 38 wherein said step of evaluating said stored data further comprises a step of testing said stored data for the occurrence of predefined conditions.

48. The method for monitoring an external database as defined in claim 38 wherein said step of evaluating further comprises executing at least one script defining an action to be performed in conjunction with said evaluating.

49. The method for monitoring an external database as defined in claim 48 wherein said at least one script is selected based on the results of said evaluations.

50. The method for monitoring an external database as defined in claim 38 wherein said script includes modifying said stored data.

51. The method for monitoring an external database as defined in claim 48 wherein said at least one script is user defined.

52. The method for monitoring an external database as defined in claim 45 further comprising a step of grouping said event procedure objects for establishing an order for the execution thereof.

53. The method for monitoring an external database as defined in claim 52 wherein said step of grouping said event procedure objects includes at least one of determining a frequency for the execution of said event procedure objects and determining a priority for the execution of event procedure objects.

54. The method for monitoring an external database as defined in claim 38 further comprising employing a plurality of servers for monitoring said external database.

55. The method for monitoring an external database as defined in claim 38 further comprising repeating said evaluations based on a frequency stored in said metadata.
